(19) United States
(12) Patent Application Publication
(10) Pub. No.: US 2022/0143814 A1
(43) Pub. Date: May 12, 2022

(54) RECONFIGURABLE CONTROLLER BASE FOR ROBOTIC ARM

(71) Applicant: OMRON Corporation, Kyoto-shi (JP)

(72) Inventor: Craig A. Johnson, Livermore, CA (US)

(21) Appl. No.: 17/454,012

(22) Filed: Nov. 8, 2021

Related U.S. Application Data
(60) Provisional application No. 63/112,516, filed on Nov. 11, 2020.

(51) Int. Cl. B25J 9/08; B25J 9/00; B25J 9/16; B25J 19/00

(52) U.S. Cl. CPC B25J 9/08; B25J 9/0009; B25J 9/042; B25J 19/0029; B25J 9/161

(57) ABSTRACT

A reconfigurable controller base for a robotic arm is provided. In one aspect, a robotic system includes a base supporting one or more articulating links, the base comprising: a main housing comprising an external structure that at least partly encloses an inner portion of the main housing, the external structure forming an opening at a back side and a bottom side of the main housing, a reconfigurable bracket configured to be removably attached to the external structure of the main housing in at least two configurations to cover the opening at the back and bottom sides of the main housing, and a controller mounted on the bracket and arranged within the inner portion of the main housing in each of the at least two configurations of the bracket, the controller configured to control actuation of the one or more articulating links.

### CROSS-REFERENCE TO RELATED APPLICATION(S)

This application claims the benefit U.S. Provisional Patent Application No. 63/112,516, filed Nov. 11, 2020, the entire disclosure of which is incorporated herein by reference.

### BACKGROUND

### Field

This application relates to robotic systems, and in particular, to systems and methods for a reconfigurable controller base for a robotic arm.

### Description

Robotic arms may be used to perform various tasks. Robotic arms typically comprise a plurality of links connected by one or more joints. The one or more joints are driven by various types of actuators (e.g., electric motors, hydraulics, etc.) to control articulation of the robotic arm to position an end effector that is configured to perform a task. The robotic arm is typically attached to a stable surface via a base which houses electronic and/or mechanical components configured to control movement and operation of the robotic arm.

### SUMMARY

In one aspect, there is provided a robotic system, comprising: a base supporting one or more articulating links, the base comprising: a main housing comprising an external structure that at least partly encloses an inner portion of the main housing, the external structure forming an opening at a back side and a bottom side of the main housing, a reconfigurable bracket configured to be removably attached to the external structure of the main housing in at least two configurations to cover the opening at the back and bottom sides of the main housing, and a controller mounted on the bracket and arranged within the inner portion of the main housing in each of the at least two configurations of the bracket, the controller configured to control actuation of the one or more articulating links.

The bracket can further comprise a plurality of connectors configured to be connected to a respective plurality of cables.

The cables can be configured to extend from the back side of the main housing when the bracket is attached to the main housing in a first one of the at least two configurations of the bracket, and the cables can be configured to extend from the bottom side of the main housing when the bracket is attached to the main housing in a second one of the at least two configurations of the bracket.

The base can comprise a plurality of mounting points along the back side and the bottom side of the main housing, and the base can be configured to be mounted to a surface adjacent to one or more of the back side and the bottom side of the main housing via the mounting points.

The bracket can comprise a first plate and a second plate, the second plate being perpendicular to the first plate, the mount housing can comprise a plurality of first mounting points at least partially surrounding the opening, and the first plate and the second plate can comprise a plurality of second mounting points positioned to be fastened to the first mounting points in each of the at least two configurations.

A shape of the bracket and the positioning of the second mounting points can be substantially symmetric with respect to a plane that bisects the first plate and the second plate.

The bracket can be further symmetric with respect to a plane extending along a longitudinal axis of the bracket.

The controller can be mounted to the first plate, in a first mode of use, the controller can be positioned adjacent to the back side of the main housing in a first one of the at least two configurations, and in a second mode of use, the controller can be positioned adjacent to the bottom side of the main housing in a second one of the at least two configurations.

The base can further comprise one or more cables connecting the controller to the one or more articulating links, the one or more cables can be configured to remain connected to the controller and the one or more articulating links while the bracket is detached from the main housing in a first one of the at least two configurations and reattached to the main housing in a second one of the at least two configurations.

In another aspect, there is provided a base of a robotic arm, comprising: a main housing comprising an external structure that at least partially encloses an inner portion of the main housing, the external structure forming an opening at a first side and a second side of the main housing, the main housing configured to support one or more articulating links of the robotic arm; a reconfigurable bracket configured to be removably attached to the external structure of the main housing in at least two configurations to cover the opening at the first side and the second side of the main housing, the bracket configured to facilitate mounting of a controller on the bracket in the at least two configurations of the bracket, wherein the controller is configured to be arranged within the inner portion of the main housing in each of the at least two configurations of the bracket, the controller being configured to control actuation of the one or more articulating links of the robotic arm.

The bracket can comprise a first plate and a second plate, the second plate being arranged at a first angle relative to the first plate, the mount housing can comprise a plurality of first mounting points at least partially surrounding the opening, and the first plate and the second plate can comprise a plurality of second mounting points positioned to be fastened to the first mounting points in each of the at least two configurations.

The positioning of the second mounting points can be substantially symmetric with respect to a plane that bisects the first plate and the second plate.

The controller can be mounted to the first plate, in a first mode of use, the controller can be positioned adjacent to the first side of the main housing in a first one of the at least two configurations, and in a second mode of use, the controller can be positioned adjacent to the second side of the main housing in a second one of the at least two configurations.

The bracket can be configured to cover the opening at a third side of the main housing, the bracket can comprise a third plate arranged at a second angle relative to the second plate, the first plate, the second plate, and the third plate can comprise the plurality of second mounting points positioned to be fastened to the first mounting points in each of the at least two configurations, in a first mode of use, the controller can be positioned adjacent to the first side of the main housing in a first one of the at least two configurations, and in a second mode of use, the controller can be positioned adjacent to the second side of the main housing in a second one of the at least two configurations.

The first angle formed between the first plate and the second plate can be about ninety degrees.

The second angle formed between the second plate and the third plate can be about ninety degrees.

In yet another aspect, there is provided a method of reconfiguring a base of a robotic arm, comprising: detaching a bracket attached to a main housing of the base, the bracket being in a first configuration relative to the main housing before being detached, the bracket being configured to cover an opening of the main housing when attached to the main housing in the first configuration, the opening being formed at a back side and a bottom side of the main housing; and reattaching the bracket to the main housing with the bracket in a second configuration, the bracket configured to cover the opening when attached to the main housing in the second configuration, wherein a controller is mounted on the bracket and arranged within the main housing in each of the first and second configurations of the bracket.

The base can supports one or more articulating links, the controller can be connected to the articulating links via one or more cables, and the detaching and reattaching of the bracket can be performed without disconnecting the cables.

### BRIEF DESCRIPTION OF THE DRAWINGS

The features and advantages of the multi-stage stop devices, systems, and methods described herein will become more fully apparent from the following description and appended claims, taken in conjunction with the accompanying drawings. These drawings depict only several embodiments in accordance with the disclosure and are not to be considered limiting of its scope. In the drawings, similar reference numbers or symbols typically identify similar components, unless context dictates otherwise. The drawings may not be drawn to scale.

FIG. 1 is an isometric view of an embodiment of a robotic arm in accordance with aspects of this disclosure.

FIG. 2 is a side view of the robotic arm of FIG. 1.

FIGS. 3A and 3B are exploded views of a base of a robotic arm having two configurations in accordance with aspects of this disclosure.

FIG. 4A illustrates a base of a robotic arm in a first configuration mounted to a horizontal surface in accordance with aspects of this disclosure.

FIG. 4B illustrates the base of the robotic arm of FIG. 4A in the first configuration mounted to a vertical surface in accordance with aspects of this disclosure.

FIG. 5A illustrates the base of a robotic arm in a second configuration mounted to a horizontal surface in accordance with aspects of this disclosure.

FIG. 5B illustrates the base of the robotic arm of FIG. 5A in the second configuration mounted to a vertical surface in accordance with aspects of this disclosure.

FIG. 6 illustrates internal components of the base in the first configuration in accordance with aspects of this disclosure.

FIG. 7 illustrates the internal components of the base in the second configuration in accordance with aspects of this disclosure.

FIGS. 8A-8E provide a plurality of views of the base in the first configuration in accordance with aspects of this disclosure.

FIGS. 9A-9E provide a plurality of views of the base in the second configuration in accordance with aspects of this disclosure.

### DETAILED DESCRIPTION

The features of the reconfigurable controller base for robotic systems, as well as related systems and methods, will now be described in detail with reference to certain embodiments illustrated in the figures. The illustrated embodiments described herein are provided by way of illustration and are not meant to be limiting. Other embodiments can be utilized, and other changes can be made, without departing from the spirit or scope of the subject matter presented. It will be readily understood that the aspects and features of the present disclosure described below and illustrated in the figures can be arranged, substituted, combined, and designed in a wide variety of different configurations by a person of ordinary skill in the art, all of which are made part of this disclosure.

Articulating robots such as robotic arms typically include unique castings and/or brackets to allow for alternative mounting configurations. Such alternative mounting configurations may include, for example, mounting the articulated robot to a horizontal surface or a vertical surface. The use of unique casting and/or brackets can prevent field updates and limit mounting options for the articulated robots.

Aspects of this disclosure related to the use of a reconfigurable controller base for a robotic arm, wherein the base includes a reconfigurable bracket onto which a controller is mounted that allows cables to exit the main housing of the robotic arm base from a back side or a bottom side of the main housing. The reconfigurable bracket facilitates the base to be mounted to a horizontal surface (e.g., table or ceiling) or a vertical (e.g., wall) surface.

For example, the reconfigurable bracket may have left and right symmetry as well as symmetry about a plane inclined at about a 45 degree angle to the bracket so that the controller as well as the cable exits and associated cover plate can be removed from the main housing, rotated about 90 degrees, and reinstalled onto the main housing.

Aspects of this disclosure provide various advantages over traditional systems. For example, the base of the robotic arm includes mounting surfaces on multiple sides, such as, for example, both the bottom and a perpendicular side to allow for multiple mounting configurations. The reconfigurable bracket provides for symmetric controller and cover mounting features that allow for cable/connector exiting from the bottom or a perpendicular side of the base using common parts. The cables can exit through an opening in the surface to which the base is mounted so that no exposed wires are visible in the work cell.

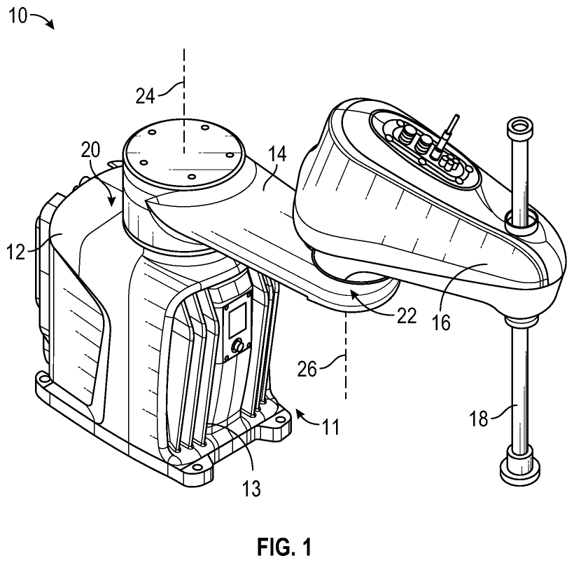

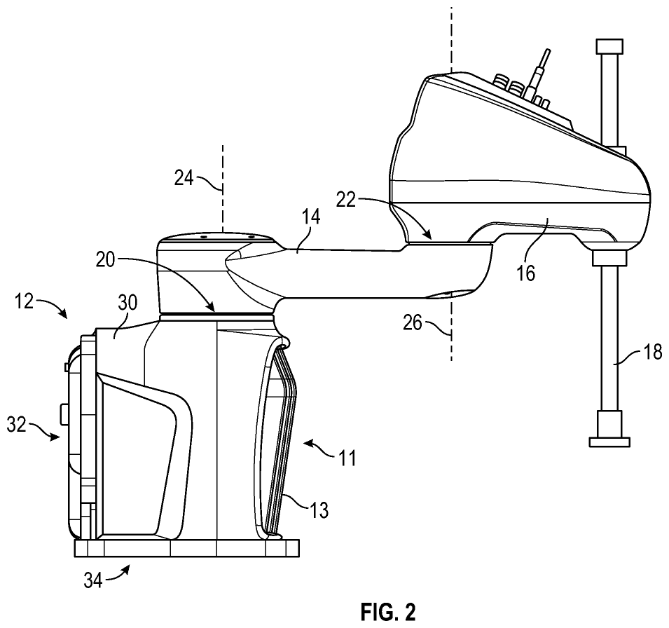

FIGS. 1 and 2 are isometric and side views, respectively, of an embodiment of a robotic system 10 that can include a reconfigurable controller base as described herein. In the illustrated embodiment of FIG. 1, the robotic system 10 comprises a robotic arm that includes a controller integrated within its base. In the illustrated embodiment, the robotic system 10 includes a base 12, one or more articulating links including a first link 14 and a second link 16, and an end effector 18. The reconfigurable controller base described herein can also be used on other types of robotic arms and systems. The illustrated robotic system 10 is provided by way of example only.

The base 12 can be configured to support the other portions of the robotic system 10, such as the first link 14, the second link 16, and the end effector 18. As illustrated, the robotic arm is supported by and extends from the base 12. In some embodiments, the base 12 includes an integrated controller for operating the robotic arm. In the illustrated embodiment, the first link 14 is connected to the base 12 by a first rotational joint 20. The first rotational joint 20 allows the first link 14 to rotate or articulate relative to the base 12. In the illustrated embodiment, the first link 14 rotates relative to the base 12 about a first axis of rotation 24. In general, rotation of the first link 14 relative to the base 12 may be controlled through the execution of one or more sequences of instructions (i.e., software) and/or by customized hardware (e.g., application-specific integrated circuit(s), field-programmable gate array(s), etc.).

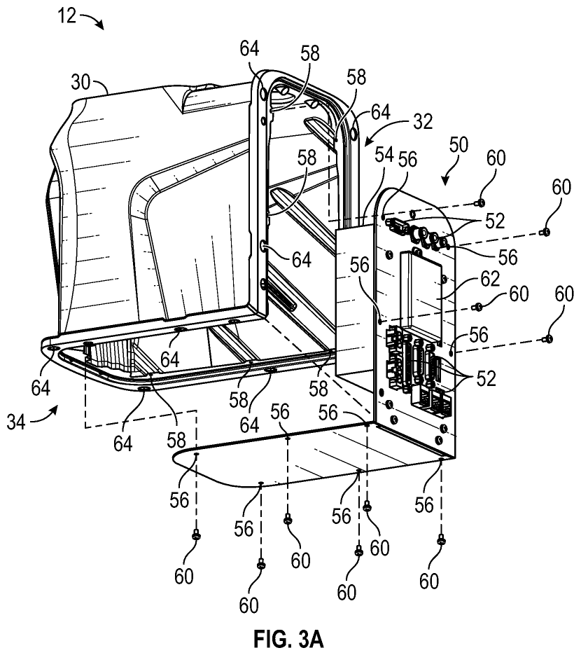

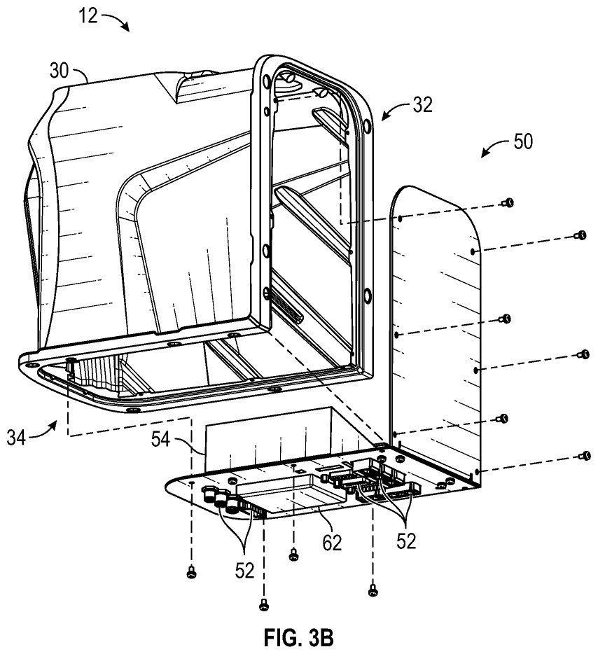

One or more motors (not illustrated) can be used to drive rotation or articulation of the first rotational joint 20. The one or more motors can be, for example, electric motors. The motors can be positioned in the base 12 and/or the first link 14. The one or more motors can be connected to one or more amplifiers 44 that are configured to drive the one or more motors. The motors can be controlled, for example, by a controller (e.g., controller 54 in FIGS. 3A and 3B). As will be described more fully below, the controller can be positioned within the base 12.

As shown in FIGS. 1 and 2, the second link 16 can be connected to the first link 14 by a second rotational joint 22. The second rotational joint 22 allows the second link 16 to rotate or articulate relative to the first link 14. In the illustrated embodiment, the second link 16 rotates relative to the first link 14 about a second axis of rotation 26. Again, in general, rotation of the second link 16 relative to the first link 14 may be controlled or limited by software or customized hardware. One or more motors (not illustrated) can be used to drive rotation or articulation of the second rotational joint 22 as described above with reference to the first rotational joint 20. Again, the one or more motors can be controlled by the controller 54, which can be positioned within the base 12.

In the illustrated embodiment, the base 12, first link 14, and second link 16 are arranged to form a selective compliance assembly robot arm (SCARA). The reconfigurable base 12 described herein may be configured for use with SCARAs and may also be configured for use with other types of robotic arms (e.g., non-SCARA) and other robotic systems.

In the illustrated embodiment of FIG. 1, the robotic system 10 includes an end effector 18. In this embodiment, the end effector 18 is positionable by rotating or articulating the first and/or second links 14, 16 about the first and/or second rotational axes 24, 26. The end effector 18 may be driven by one or more motors. The one or motors can be controlled by the controller 54, which can be positioned within the base 12. Specifically, the controller 54 is configured to control actuation of the one or more articulating links. The end effector 18 can be configured to perform various tasks as will be apparent to those of ordinary skill in the art.

The base 12 may house (e.g., partially or fully enclose) many of the electronic components of the robotic system 10. In some embodiments, the base 12 houses the integrated controller 54. The controller 54 may comprise one or more components configured to control or allow control of the robotic arm. In some instances, it may be advantageous to include the controller 54 within the base 12. For example, housing the controller 54 within the base 12 removes the need for a separate controller, which can simplify the robotic system 10. At the same time, integrating the controller 54 into the base 12 adds additional components to the base 12.

In some embodiments, the controller 54, which may comprise one or more processor boards, may be mounted to a flange or bracket 50. As mentioned above, the base 12 may house the integrated controller 54, the amplifiers 44, and motor controllers associated with motion of the first link 14, the second link 16, and the end effector 18. Other components can also be positioned within the base 12. In related aspects, a front portion 11 of the base 12 may comprise one or more fins 13 configured to dissipate heat.

With reference to FIG. 2, the base 12 includes a main housing 30 which has a back side 32 and a bottom side 34. The main housing 30 may have a substantially cuboid shape with six sides including the back side 32 and the bottom side 34. However, this disclosure is not limited thereto and the main housing 30 may have any shape that enables a reconfigurable bracket to be attached thereto as described herein.

Aspects of this disclosure relate to a robotic arm which can be configured to perform various tasks, including pick and place activities, grabbing objects and putting the objects in bins, electronics assembly, glue dispensing via a nozzle, etc. In one example a first robotic arm can be configured as a glue dispenser and second robotic arm can be configured to place screen onto the glue e.g., during the assembly of a phone.

FIGS. 3A and 3B illustrate the reconfigurable base 12 of the robotic system 10 in two different configurations in accordance with aspects of this disclosure. As shown in FIG. 3A and 3B, the base 12 includes a main housing 30 and a reconfigurable bracket (also referred to simply as the “bracket”) 50. In the illustrated implementation, the main housing 30 includes an opening formed at the back side 32 and the bottom side 34 of the main housing 30. In other implementations, the opening may be formed on any two or more adjacent sides of the main housing 30.

The main housing further includes a plurality of bracket mounting points 58 configured to fasten the bracket 50 to the main housing 30 and a plurality of surface mounting points 64 configured to fasten the base 12 to a surface. The bracket mounting points 58 and the surface mounting points 64 are located along the back side 32 and the bottom side 34 of the main housing 30. The base 12 is configured to be mounted to the surface adjacent to the back side 32 and/or the bottom side 34 of the main housing 30 via the surface mounting points 64.

The main housing 30 includes an external structure that at least partly encloses an inner portion of the main housing 30 which encloses and protects the components positioned therein. The external structure of the main housing 30 forms the opening to which the bracket 50 can be attached.

The bracket 59 includes a plurality of connectors 52, a plurality of mounting points 56, and a cover 62. The bracket 50 can provide an interface through which cabling can exit the base 12. The connectors 52 are located on the bracket 50 and are configured to be connected to a plurality of cables. For example, the connectors 52 may be configured to couple to one or more cables configured to receive communications from a remote location (e.g., a server providing instructions to the robotic system 10) as well as power to run the controller 54 and other components of the robotic arm. The controller 54 is mounted to the bracket 50 and can be enclosed on an external side of the bracket via the cover 62. In some implementations, when the base 12 is installed onto a surface, the cover 62 can be removed to allow one or more cables to be directly connected to the controller through the opening exposed by removing the cover 62. The bracket 50 is configured to be attached to the main housing 30 via a plurality of fasteners 60 that engage the mounting points 56 and 58. It is noted that bracket 50 can be removably attached to the main housing 30 using any number of different types of connectors, fasteners, adhesives, etc. depending on the particular application.

According to aspects of this disclosure, the bracket 50 may be reconfigurable with respect to the remainder of the base 12. In addition to providing a mounting location for the controller 54, the bracket 50 may also the base 12 to be mounted to at least one of a horizontal surface such as on a table and a vertical surface such as on a wall. In other implementations, the base 12 can also be mounted to other surface, such as the ceiling or below a horizontal surface.

The bracket 50 is configured to be removably attached to the external structure of the main housing 30 in at least two configurations to cover the opening at the back and bottom sides 32 and 34 of the main housing 30. For example, the bracket 50 is configured to be mounted to the main housing 30 in a first configuration shown in FIG. 3A in which the controller 54, connectors 52, and cover 62 are positioned adjacent to the back side 32 of the main housing 30 and a second configuration shown in FIG. 3B in which the controller 54, connectors 52, and cover 62 are positioned adjacent to the bottom side 34 of the main housing 30. The controller 54 is mounted on the bracket 50 such that the controller 54 is arranged within the inner portion of the main housing 30 in each of the at least two configurations of the bracket.

In the first configuration shown in FIG. 3A, the cables are configured to extend from the back side 32 of the main housing 30. Similarly, in the second configuration shown in FIG. 3B, the cables are configured to extend from the bottom side 43 of the main housing 30.

The bracket 50 of the implementation of FIGS. 3A and 3B is formed to have a substantially L-shape. In certain embodiments, the bracket 50 can be formed as a single piece (e.g., from a single piece of sheet metal) or may be formed or two or more plates attached together. The L-shaped bracket 50 includes a first plate 51 and a second plate 53. The second plate 53 may be perpendicular to the first plate 51 to form the L-shape bracket 50. Additionally, the size and shape of each of the first plate 51 and a second plate 53 may be substantially the same such that the bracket 50 covers the opening in each of the first and second configurations.

In order to enable the same bracket 50 to be configured in each of the first and second configurations, the main housing 30 and the bracket 50 may have a certain amount of symmetry. For example, each of the mounting points 56 on the bracket 50 can be secured to the mounting points 58 on the main housing 30 in each of the first and second configurations. The shape of the bracket 50 and the positioning of the mounting points 56 thereon can be substantially symmetric with respect to a plane that bisects the first plate 51 and the second plate 53. When the first plate 51 and the second plate 53 are perpendicular, the bisecting plane may be 45° from each of the first and second plates 51 and 53. The positioning of the mounting points 58 on the main housing 30 may also be symmetrical with respect to a plane bisecting an angle formed between the back side 32 and bottom side 34 of the main housing 30. In addition, the bracket 50 can be further symmetric with respect to a plane extending along a longitudinal axis of the bracket 50.

The symmetry within the bracket 50 and the main housing 30 enables the same mounting points 56 and 58 to be reused in each of the first and second configurations. Thus, the base 12 can be designed with a fewer number of mounting points 56 and 58. However, in other implementations, the mounting points 56 and 58 may not be symmetrical, and thus, a greater number of mounting points 56 and/or 58 may be provided such that the bracket 50 can be attached to the main housing 30 in the first and second configurations.

Since the controller 54 is mounted to the first plate 51, the location of the controller 54 may vary depending on the current configuration of the bracket 50 mounted to the main housing 30. For example, in a first mode of use, the controller 54 can be positioned adjacent to the back side 32 of the main housing 30 in the first configuration as shown in FIG. 3A and in a second mode of use, the controller 54 can be positioned adjacent to the bottom side 34 of the main housing 30 in the second configurations as shown in FIG. 3B.

In related aspects, an opening of the main housing 30 may have three or more sides, and a corresponding bracket may have three or more sides to cover respective sides of the opening. In other words, the shape and corresponding angles of the bracket or similar cover are not limited to L-shape with two sides at a ninety-degree angle relative to each other. Although FIGS. 3A and 3B illustrate an implementation in which the bracket 50 covers the back side 32 and bottom side 34, aspects of this disclosure also relate to implementations in which a reconfigurable bracket 50 can cover an opening in the main housing 30 in any two or more adjacent sides of the main housing 30. For example, in an implementation in which the opening extends along three adjacent sides of the main housing 30, the bracket 50 may have a U-shape that covers the three adjacent sides. The controller 54 can be mounted to any one side of the U-shaped bracket 50. In other implementations, the opening may extend along three sides of the main housing 30 such that each pair of the sides are adjacent to each other. In this implementation, there may be three different configurations in which the bracket 50 can be attached to the main housing 30.

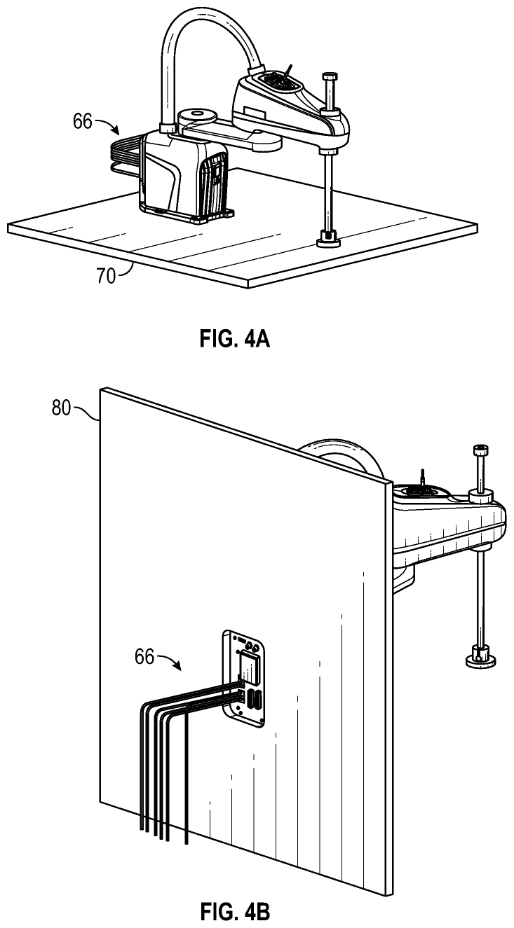

FIG. 4A illustrates another embodiment of a robotic arm, wherein the base 12 of the robotic arm in the first configuration mounted to a horizontal surface 70 and FIG. 4B illustrates the base 12 of the robotic arm in the first configuration mounted to a vertical surface 80. As shown in FIGS. 4A and 4B, the cables 66 exit the base 12 from the back side of the main housing in the first configuration. When mounted to the horizontal surface 70 (e.g., a table, counter, rack, etc.) in the first configuration as illustrated in FIG. 4A, the cables 66 may be exposed after exiting the base 12. In contrast, when mounted to the vertical surface 80 (e.g., a wall) in the first configuration as illustrated in FIG. 4B, the cables 66 may be hidden within behind the vertical surface 80. Routing the cables 66 through the wall can be advantageous by protecting the cables from the environment, thereby preventing dust from accumulating on the cables 66, preventing the cables 66 from being snagged by other devices and/or people within the environment, etc.

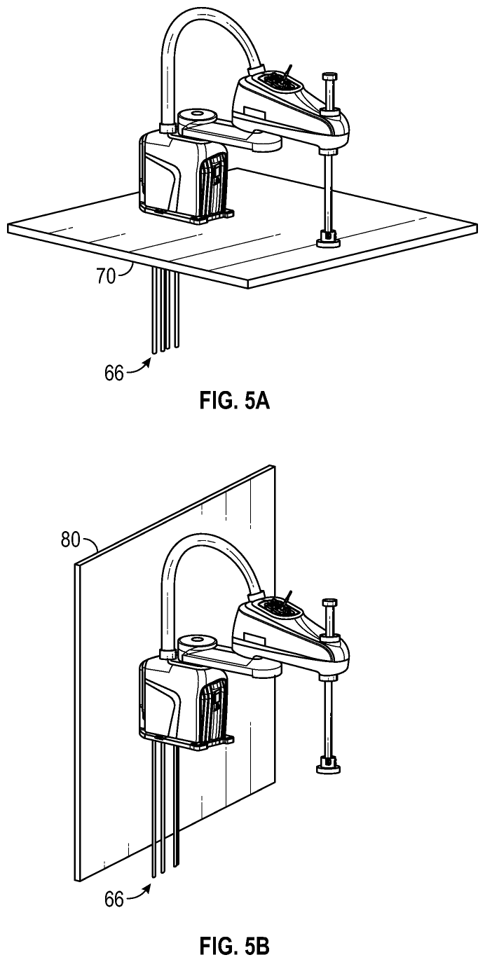

FIG. 5A illustrates the base 12 of the robotic arm in the second configuration mounted to a horizontal surface 70 and FIG. 5B illustrates the base 12of the robotic arm in the second configuration mounted to a vertical surface 80. As shown in FIGS. 5A and 5B, the cables 66 exit the base 12 from the bottom side of the main housing in the second configuration. When mounted to the horizontal surface 70 in the second configuration as illustrated in FIG. 5A, the cables 66 may be hidden beneath the horizontal surface 70. In contrast, when mounted to the vertical surface 80 in the second configuration as illustrated in FIG. 5B, the cables 66 may be exposed after exiting the base 12. Routing the cables 66 through the horizontal surface 70 (e.g., through a table) can be advantageous by protecting the cables from the environment, thereby preventing dust from accumulating on the cables 66, preventing the cables 66 from being snagged by other devices and/or people within the environment, etc.

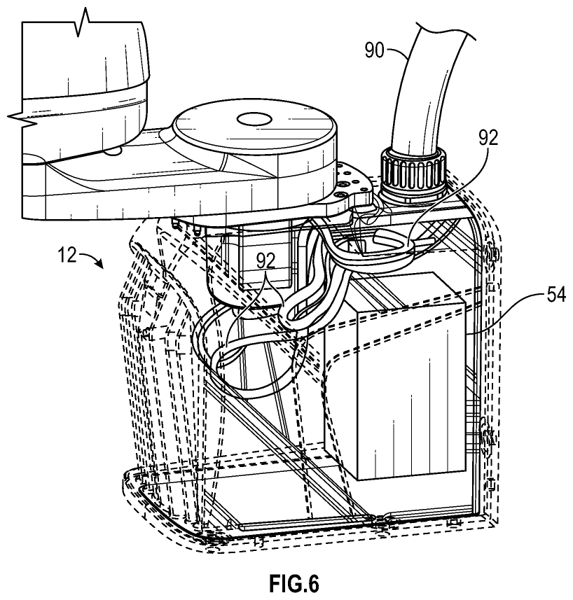

FIG. 6 illustrates internal components of the base 12 in the first configuration in accordance with aspects of this disclosure. As shown in FIG. 6, the controller 54 is housed in the base 12 near the back side of the base 12. The base 12 is connected to a flexible cable housing or conduit 90 which is configured to route one or more cables 92 from the controller 54 to the one or more articulating links of the robotic arm (e.g., the link 16). The inner portion of the base 12 can include sufficient space to allow the cables 92 to be enclosed within the base 12.

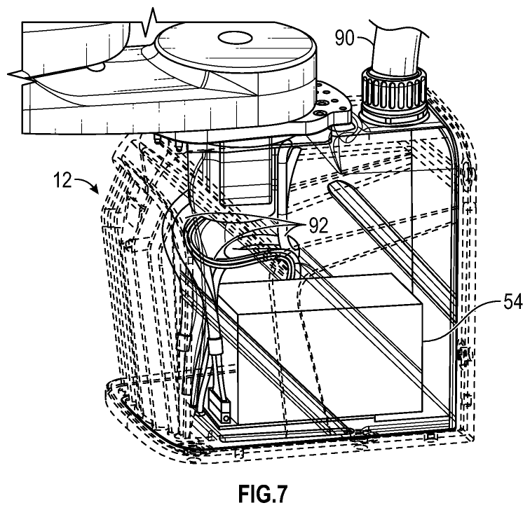

FIG. 7 illustrates the internal components of the base in the second configuration in accordance with aspects of this disclosure. As shown in FIG. 7, the controller 54 is housed in the base 12 near the bottom side of the base 12. The cables 92 have sufficient length to extend from the controller 54 to the conduit 90 in both the first and second configurations. In addition, there may be sufficient slack in the cables 92 to enable the bracket to be detached and reattached without disconnecting the cables 92. Thus, the cables 92 can remain connected to the controller 54 and the one or more articulating links via the conduit 90 while the bracket is detached from the main housing in one configuration and reattached to the main housing in another configuration. This can reduce the time and simplify the actions involved in reconfiguring the bracket between the first and second configurations.

In certain implementations, reconfiguration of the base 12 may involve detaching the bracket 50 from the main housing 30. Prior to being detached, the bracket 50 may be in a first configuration relative to the main housing 30. As described herein, the bracket 50 is configured to cover the opening of the main housing 30 when attached to the main housing 30 in the first configuration. The reconfiguration of the base 12 may further involve reattaching the bracket 50 to the main housing 30 with the bracket 50 in a second configuration. The bracket 50 also is configured to cover the opening when attached to the main housing 30 in the second configuration. In certain embodiments, the detaching and reattaching of the bracket can be performed without disconnecting the cables 92 that connect the controller 54 to the articulating links of the robotic arm.

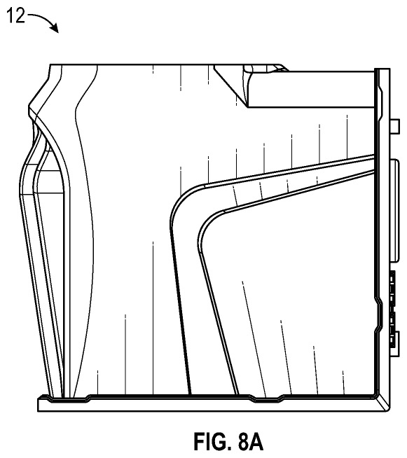

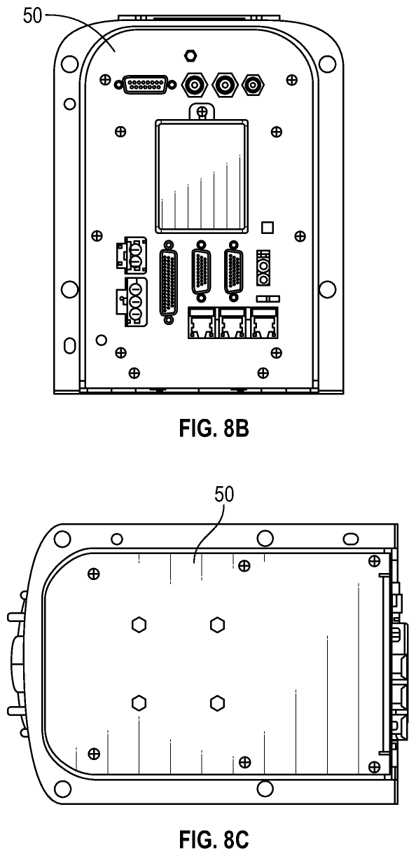

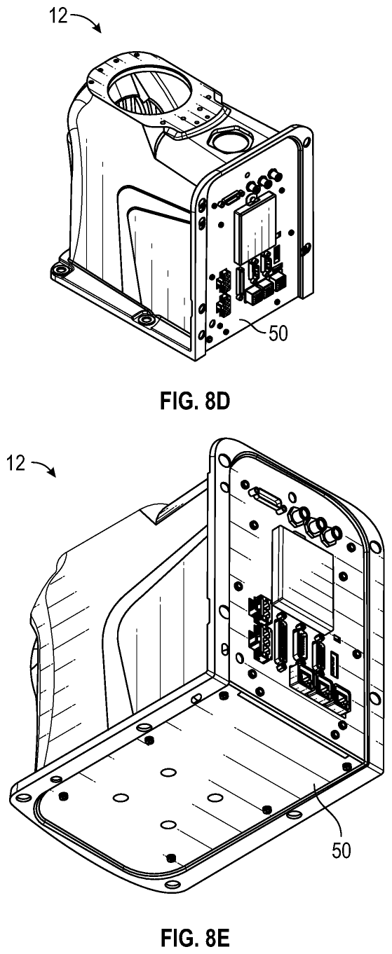

FIGS. 8A-8E provide a plurality of views of the base in the first configuration in accordance with aspects of this disclosure. In particular, FIG. 8A is a view of the side of the base 12, FIG. 8B is a view of the back of the base 12, FIG. 8C is a view of the bottom of the base 12, FIG. 8D is an isometric view of the base 12 from above, and FIG. 8E is an isometric view of the base 12 from below.

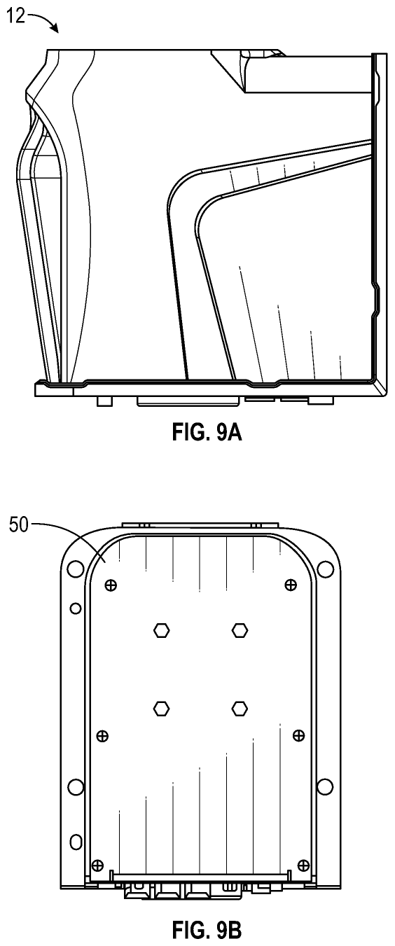

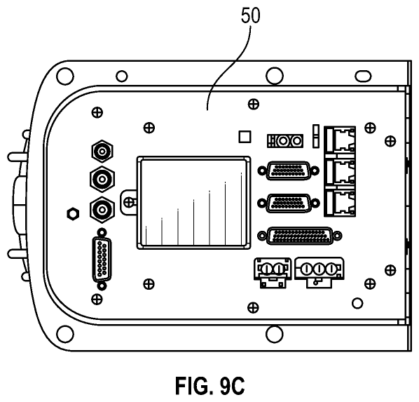

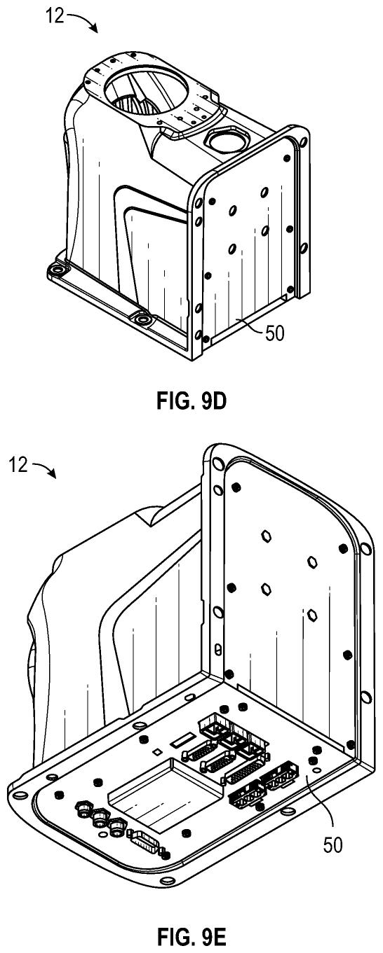

FIGS. 9A-9E provide a plurality of views of the base in the second configuration in accordance with aspects of this disclosure. In particular, FIG. 9A is a view of the side of the base 12, FIG. 9B is a view of the back of the base 12, FIG. 9C is a view of the bottom of the base 12, FIG. 9D is an isometric view of the base 12 from above, and FIG. 9E is an isometric view of the base 12 from below.

Aspects of this disclosure relate to a robotic system that include a bracket 50 enabling a base 12 to be mounted to both a horizontal surface (e.g., a table) and a vertical surface (e.g., a wall). This allows the base 12 of the robot to be table-mounted or wall-mounted without the need for additional brackets or adapters, which can be costly to produce and wasteful when not used in a particular installation. The reconfigurable bracket 50 allows options for the direction from which cables exit from the base 50. By using the base 12 described herein, one set of parts can be used for multiple configurations such that there is no need for separate casting of the base 12 or providing an additional bracket for mounting the base 12 in the second configuration. Aspects of this disclosure also allow for the clean up the work cell in which the robotic system is installed by having the cables come out of the bottom of the base 12, thereby removing the need to wipe down exposed cables.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes can be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures can be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

Directional terms used herein (e.g., top, bottom, side, up, down, inward, outward, etc.) are generally used with reference to the orientation shown in the figures and are not intended to be limiting. For example, the top surface described above can refer to a bottom surface or a side surface. Thus, features described on the top surface may be included on a bottom surface, a side surface, or any other surface.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method steps.

The above description discloses several methods and materials of the present invention(s). This invention(s) is susceptible to modifications in the methods and materials, as well as alterations in the fabrication methods and equipment. Such modifications will become apparent to those skilled in the art from a consideration of this disclosure or practice of the invention(s) disclosed herein. Consequently, it is not intended that this invention(s) be limited to the specific embodiments disclosed herein, but that it cover all modifications and alternatives coming within the true scope and spirit of the invention(s) as embodied in the attached claims.

What is claimed is:

1. A robotic system, comprising:
a base supporting one or more articulating links, the base comprising:
a main housing comprising an external structure that at least partly encloses an inner portion of the main housing, the external structure forming an opening at a back side and a bottom side of the main housing,
a reconfigurable bracket configured to be removably attached to the external structure of the main housing in at least two configurations to cover the opening at the back and bottom sides of the main housing, and
a controller mounted on the bracket and arranged within the inner portion of the main housing in each of the at least two configurations of the bracket, the controller configured to control actuation of the one or more articulating links.

2. The robotic system of claim 1, wherein the bracket further comprises a plurality of connectors configured to be connected to a respective plurality of cables.

3. The robotic system of claim 2, wherein:
the cables are configured to extend from the back side of the main housing when the bracket is attached to the main housing in a first one of the at least two configurations of the bracket, and
the cables are configured to extend from the bottom side of the main housing when the bracket is attached to the main housing in a second one of the at least two configurations of the bracket.

4. The robotic system of claim 1, wherein:
the base comprises a plurality of mounting points along the back side and the bottom side of the main housing, and
the base is configured to be mounted to a surface adjacent to one or more of the back side and the bottom side of the main housing via the mounting points.

5. The robotic system of claim 1, wherein:
the bracket comprises a first plate and a second plate, the second plate being perpendicular to the first plate,
the mount housing comprises a plurality of first mounting points at least partially surrounding the opening, and
the first plate and the second plate comprise a plurality of second mounting points positioned to be fastened to the first mounting points in each of the at least two configurations.

6. The robotic system of claim 5, wherein a shape of the bracket and the positioning of the second mounting points are substantially symmetric with respect to a plane that bisects the first plate and the second plate.

7. The robotic system of claim 6, wherein the bracket is further symmetric with respect to a plane extending along a longitudinal axis of the bracket.

8. The robotic system of claim 5, wherein:
the controller is mounted to the first plate,
in a first mode of use, the controller is positioned adjacent to the back side of the main housing in a first one of the at least two configurations, and
in a second mode of use, the controller is positioned adjacent to the bottom side of the main housing in a second one of the at least two configurations.

9. The robotic system of claim 1, wherein the base further comprises:
one or more cables connecting the controller to the one or more articulating links,
wherein the one or more cables are configured to remain connected to the controller and the one or more articulating links while the bracket is detached from the main housing in a first one of the at least two configurations and reattached to the main housing in a second one of the at least two configurations.

10. A base of a robotic arm, comprising:
a main housing comprising an external structure that at least partially encloses an inner portion of the main housing, the external structure forming an opening at a first side and a second side of the main housing, the main housing configured to support one or more articulating links of the robotic arm;
a reconfigurable bracket configured to be removably attached to the external structure of the main housing in at least two configurations to cover the opening at the first side and the second side of the main housing, the bracket configured to facilitate mounting of a controller on the bracket in the at least two configurations of the bracket,
wherein the controller is configured to be arranged within the inner portion of the main housing in each of the at least two configurations of the bracket, the controller being configured to control actuation of the one or more articulating links of the robotic arm.

11. The base of claim 10, wherein:
the bracket comprises a first plate and a second plate, the second plate being arranged at a first angle relative to the first plate,
the mount housing comprises a plurality of first mounting points at least partially surrounding the opening, and
the first plate and the second plate comprise a plurality of second mounting points positioned to be fastened to the first mounting points in each of the at least two configurations.

12. The base of claim 11, wherein the positioning of the second mounting points are substantially symmetric with respect to a plane that bisects the first plate and the second plate.

13. The base of claim 11, wherein:
the controller is mounted to the first plate,
in a first mode of use, the controller is positioned adjacent to the first side of the main housing in a first one of the at least two configurations, and
in a second mode of use, the controller is positioned adjacent to the second side of the main housing in a second one of the at least two configurations.

14. The base of claim 11, wherein:
the bracket is configured to cover the opening at a third side of the main housing,
the bracket comprises a third plate arranged at a second angle relative to the second plate,
the first plate, the second plate, and the third plate comprise the plurality of second mounting points positioned to be fastened to the first mounting points in each of the at least two configurations,
in a first mode of use, the controller is positioned adjacent to the first side of the main housing in a first one of the at least two configurations, and
in a second mode of use, the controller is positioned adjacent to the second side of the main housing in a second one of the at least two configurations.

15. The base of claim 14, wherein the first angle formed between the first plate and the second plate is about ninety degrees.

16. The base of claim 15, wherein the second angle formed between the second plate and the third plate is about ninety degrees.

17. A method of reconfiguring a base of a robotic arm, comprising:
detaching a bracket attached to a main housing of the base, the bracket being in a first configuration relative to the main housing before being detached, the bracket being configured to cover an opening of the main housing when attached to the main housing in the first configuration, the opening being formed at a back side and a bottom side of the main housing; and
reattaching the bracket to the main housing with the bracket in a second configuration, the bracket configured to cover the opening when attached to the main housing in the second configuration,
wherein a controller is mounted on the bracket and arranged within the main housing in each of the first and second configurations of the bracket.

18. The method of claim 17, wherein:
the base supports one or more articulating links,
the controller is connected to the articulating links via one or more cables, and
the detaching and reattaching of the bracket is performed without disconnecting the cables.
